(19) United States
(12) Patent Application Publication
(10) Pub. No.: US 2013/0186563 A1
(43) Pub. Date: Jul. 25, 2013

(54) METHOD FOR ATTACHING GUIDE RING TO ROLLER AND JIG FOR ATTACHING GUIDE RING

(71) Applicant: Daisuke Shoji, Sennan-gun (JP)

(72) Inventor: Daisuke Shoji, Sennan-gun (JP)

(73) Assignee: SUMITOMO ELECTRIC FINE POLYMER, INC., Sennan-gun, Osaka (JP)

(21) Appl. No.: 13/876,416

(22) PCT Filed: Mar. 9, 2012
(86) PCT No.: PCT/JP2012/056129

§ 371 Date: Mar. 27, 2013

(30) Foreign Application Priority Data
Mar. 15, 2011 (JP) 2011-057045

(51) Int. Cl. B32B 37/10

(52) U.S. Cl. CPC B32B 37/10
USPC 156/293; 156/423

(57) ABSTRACT

A jig provided with a holding protrusion is used; a guide is overlaid on an outer circumferential surface of the holding protrusion; the guide ring is compressed toward an inner circumferential side through a decompression hole opened in the outer circumferential surface of the holding protrusion; the guide ring is brought into close contact with the outer circumferential surface of the holding protrusion; an adhesive is applied to an outer circumferential surface of the guide ring; the roller is overlaid on the guide ring; pressure reduction is released to return the guide ring to its original outer diameter and press the adhesive applied to the outer circumferential surface of the guide ring against an inner circumferential surface of the roller; and after adhesively fixing the guide ring to the inner circumferential surface, the roller is removed from the jig.

### TECHNICAL FIELD

The present invention relates to a method for attaching a guide ring to a roller and a jig for attaching the guide ring, and specifically to a method for adhesively fixing a guide ring made of an annular elastic body to the inner circumferential surface of a cylindrical roller, by which a spindle is caused to pass through a roller to which the guide ring is adhered at its inner circumferential surface on both ends in the axis direction, so as to allow this roller to be suitably used in the fixing unit of an image forming apparatus.

### BACKGROUND ART

The roller in the fixing unit as described above is used for heat-fixing a toner image on paper or the like. As shown in FIGS. 21 and 22, this roller is configured as a roller R made of resin and formed of an elliptical sleeve body (this roller may be referred to as a belt), in which guide rings G1 and G2 each made of an elastic body are adhesively fixed to the inner circumferential surface of this roller R on both ends in the axis direction; roller R is overlaid on two metal spindles S1 and S2 made of steel or aluminum; and guide rings G1 and G2 each are fit onto small diameter portions of spindles S1 and S2 located on both ends in the axis direction. Thus, when roller R rotates, guide rings G1 and G2 each are brought into contact with the edges of large diameter portions of spindles S1 and S2, thereby preventing roller R from being displaced in the axis direction. It is to be noted that the number of spindles may be two or more.

For example, Japanese Patent Laying-Open No. 2010-101423 (PTL 1) proposes a method shown in FIGS. 23 to 27 as a method for adhesively fixing the guide ring to the inner circumferential surface of the roller. This roller is supported by one axis, in which one spindle is inserted through the center of a cylindrical roller.

Specifically, as shown in FIG. 23, a molded body 50 is used as a jig configured such that a fitting portion 52 in the shape of a circular protrusion is provided in the center on the upper surface of a fitting drum 51, a flange 53 is provided on the outer circumference of fitting portion 52, and a recessed portion 52a is provided in a part of an outer circumferential surface of fitting portion 52. Guide ring 55 in the compressed state is fit onto fitting portion 52 of molded body 50 while a remaining portion 55a of guide ring 55 is housed in recessed portion 52a by employing guide protrusion 52b. Also, as shown in FIGS. 24 and 25, an adhesive 61 is applied to the inner circumferential surface of cylindrical sleeve 60 at its axial end, and sleeve 60 is overlaid on guide ring 55 made of an elastic body and fit onto fitting portion 52 of molded body 50, to semi-fix this sleeve 60 to guide ring 55 with adhesive 61. Then, as shown in FIG. 26, sleeve 60 is removed from molded body 50, remaining portion 55a of guide ring 55 not adhering to sleeve 60 is pressed by the operator's hand against along the inner circumferential surface of sleeve 60, and adhered to this inner circumferential surface. Guide ring 55 is similarly adhesively fixed also to the inner circumferential surface of sleeve 60 on the other end in the axis direction to form a fixing roller 65, through which spindle 62 is inserted as shown in FIG. 27.

### CITATION LIST

### Patent Literature

PTL 1: Japanese Patent Laying-Open No. 2010-101423

### SUMMARY OF INVENTION

### Technical Problem

In the method for attaching a guide ring to a fixing roller in PTL 1 shown in FIGS. 23 to 27 as described above, adhesive 61 is applied in advance to the inner circumferential surface of sleeve 60 to be used as a roller, which causes a problem that an adhesive may tend to be unevenly applied to the inner circumferential surface of the sleeve during the application operation. It is also necessary to move sleeve 60 in the state where the adhesive is applied to the inner circumferential surface of the sleeve, to accurately overlay this sleeve on guide ring 55 wound around fitting portion 52 of molded body 50. In this case, if sleeve 60 is not accurately overlaid on molded body 50, the adhesive applied to the inner circumferential surface of the sleeve tends to adhere to other portions before this adhesive adheres to the outer circumferential surface of guide ring 55, which also causes a problem that the workability is significantly deteriorated. Furthermore, molded body 50 needs to be configured to have a recessed portion 52a in fitting portion 52 onto which guide ring 55 is fit and also have a guide protrusion 52b accurately provided in recessed portion 52a with a prescribed gap. It is also necessary to perform such an operation that guide ring 55 is stretched and overlaid on fitting portion 52, and remaining portion 55a is caused to pass through the gap between recessed portion 52a and guide protrusion 52b. Furthermore, after guide ring 55 is semi-fixed to the inner circumferential surface of sleeve 60, sleeve 60 is separated from molded body 50. In this case, if adhesive 61 applied to the inner circumferential surface of sleeve 60 adheres to flange 53, it becomes difficult to remove sleeve 60 from molded body 50. Furthermore, after removing sleeve 60 from molded body 50, the operator needs to press remaining portion 55a of guide ring 55 against the inner surface of sleeve 60 and adhere this remaining portion to the inner surface, thereby fully fixing guide ring 55 thereto. In this way, a lot of processes should be performed by the operator, which causes problems that the finished accuracy may vary depending on the operator's level of skill, and the like.

The present invention has been made in light of the above-described problems. The first object of the present invention is to provide a method for attaching a guide ring to a roller, by which an operation to be performed by the operator is simplified, variations depending on the operator's level of skill are reduced, and the quality is stabilized. The second object of the present invention is to provide a jig used in this method.

### Solution to Problem

In order to solve the above-described problems, a method for adhering a guide ring made of an elastic body to an inner circumferential surface of a cylindrical roller is provided as the first invention. The method is characterized by using a jig provided with a holding protrusion from an upper surface of a supporting base; overlaying the guide ring on an outer circumferential surface of the holding protrusion; reducing pressure from an inner circumferential side of the guide ring through a decompression hole opened in the outer circumferential surface of the holding protrusion, to bring the guide ring into close contact with the outer circumferential surface of the holding protrusion; applying an adhesive to an outer circumferential surface of the guide ring; overlaying the roller on the guide ring from an end opening in an axis direction; releasing the pressure reduction to restore an outer diameter of the guide ring, to press the adhesive applied to the outer circumferential surface of the guide ring against the inner circumferential surface of the roller; and removing from the jig the roller having the inner circumferential surface to which the guide ring is adhesively fixed.

When the guide ring is overlaid on the holding protrusion, an insertion end face of the guide ring is brought into contact with the upper surface of the supporting base of the jig, and an end face of an opening on one end of the roller in the axis direction is also brought into contact with the upper surface of the supporting base of the jig, to adhesively fix one end of the roller in the axis direction and one end of the guide ring in line. The guide ring is adhesively fixed also to the inner circumferential surface of the roller on the other end in the axis direction by the same method as described above. The above-described method is used to insert and fix a spindle to the roller to which a pair of guide rings are adhesively fixed at its inner circumferential surfaces on both ends in the axis direction, thereby forming a roller for a fixing unit.

In the present invention, a guide ring made of a rubber ring is wound around a holding protrusion corresponding to a fitting portion of a jig in PTL 1, and an adhesive is applied in the state where the guide ring is compressed by pressure reduction. In this way, since the outer circumferential surface of the guide ring made of an elastic body is used as a surface to which an adhesive is applied, the adhesive can be applied more readily than in the case where the adhesive is applied to the inner circumferential surface of the roller, and also the adhesive can be applied to the guide ring in uniform thickness and without unevenness. Furthermore, the holding protrusion onto which the guide ring is fit has an outer circumferential surface formed in the shape of a simple circle and an outer diameter smaller than the inner diameter of the guide ring. Accordingly, without having to stretch the guide ring, the guide ring with its original diameter only has to be overlaid on the outer circumferential surface of the holding protrusion. Thus, the operation for attaching the guide ring to the holding protrusion can be simplified while the configuration of the jig can also be simplified. Furthermore, when the roller is overlaid on the guide ring fit onto the holding protrusion, the outer diameter of the guide ring is compressed by pressure reduction through the decompression hole opened in the outer circumferential surface of the holding protrusion, thereby allowing the roller to be readily overlaid on the guide ring with a reduced diameter. When pressure reduction is released after the roller is overlaid, the compressed guide ring returns to its original state and the outer diameter thereof returns to its original size, with the result that the surface of the guide ring to which the adhesive is applied can be brought into close contact with the inner circumferential surface of the roller and pressed against it. In other words, unlike PTL 1, the operator does not need to perform a manual operation to press a remaining portion of the guide ring against the inner circumferential surface of the roller for adhesion, and the outer circumferential surface of the guide ring can be automatically brought into close contact with the inner circumferential surface of the roller.

It is preferable that the outer diameter of the guide ring is reduced by 0.5% to 8% in a state where the guide ring is compressed by pressure reduction. By reducing the outer diameter by 0.5% to 8% in this way, a roller insertion space is provided between the outer circumferential surface of the guide ring to which the adhesive is applied and the inner circumferential surface of the roller, thereby making it easy to dispose the roller on the outer circumference of the guide ring. Also, since the outer diameter is reduced by 0.5% to 8%, the outer diameter immediately returns to its original diameter when pressure reduction is released, so that the adhesive on the outer circumferential surface can be adhered to the inner circumferential surface of the roller.

After applying the adhesive to the guide ring fit onto the holding protrusion, a collar (cylindrical guide frame) may be disposed with a roller insertion space provided from the outer circumferential surface of the guide ring, and the roller may be inserted into the insertion space between the collar and the guide ring. By disposing the collar in this way, the roller can be accurately fit onto the guide ring, thereby allowing improvement in workability.

As the second invention, a jig used in the method for attaching a guide ring to a roller is provided. A holding protrusion having an outer diameter smaller than an inner diameter of the guide ring is disposed to protrude from an upper surface of a supporting base, and a decompression hole is opened in an outer circumferential surface of the holding protrusion. This jig includes pressure reducing means for reducing pressure through the decompression hole in a state where the guide ring is fit onto the holding protrusion, to bring the guide ring into close contact with the outer circumferential surface of the holding protrusion and allow the guide ring to be compressed.

Specifically, a screw hole is opened in the center on the upper surface of the supporting base in a shape of a circular seat, an annular high step portion surrounding the screw hole is provided, an annular middle step portion is provided in an outer circumference of the high step portion, a decompression hole is opened in the middle step portion, and a low step portion including a surface of the supporting base is provided in an outer circumference of the middle step portion; while a disk-shaped top plate is provided that has a lower surface from which a screw rod protrudes that is to be screwed into the screw hole of the supporting base. The screw rod of the top plate is screwed into the screw hole of the supporting base, and the top plate is fixedly placed on an upper surface of the high step portion, to provide the holding protrusion having a gap provided between a lower surface of the top plate and an upper surface of the middle step portion, in which the decompression hole is opened to the gap. The guide ring is fit onto the outer circumferential surface of the holding protrusion, and a load is introduced through the decompression hole into the gap located in an intermediate portion of the holding protrusion, to reduce pressure from an inner circumferential side of the guide ring, and then, an adhesive is applied to the outer circumferential surface of the guide ring.

As described above, after the adhesive is applied to the guide ring and before the roller is fit onto the guide ring, the collar may be disposed on the supporting base and the roller may be inserted between the collar and the guide ring. By attaching the collar in this way, the roller can be readily attached while the diameter of the guide ring can be equally increased when pressure reduction is released to return the guide ring to its original state and increase the diameter.

Furthermore, in the case where the supporting base is rotatably mounted on a base through a bearing, when the supporting base is rotated to rotate the guide ring during application of an adhesive to the outer circumferential surface of the guide ring, the adhesive can be simply and accurately applied to the outer circumferential surface of the guide ring by using adhesive applying means disposed at a fixed position.

### Advantageous Effects of Invention

As described above, according to the present invention, a guide ring made of an elastic body is fit onto a holding protrusion of a jig, and an adhesive is applied to the outer circumferential surface of the guide ring in the state where the guide ring is compressed under pressure reduction. Consequently, the operation for applying the adhesive can be simplified. Furthermore, since the roller is overlaid on the compressed guide ring to press the adhesive applied to the outer circumferential surface of the guide ring against the inner circumferential surface of the roller, the guide ring can be adhesively fixed to the inner circumferential surface of the roller automatically. In this way, by decreasing the number of manually operated processes among the processes of attaching the guide ring to the roller, and also by simplifying the manually operated process, it becomes possible to reduce variations in quality and improve the quality.

Furthermore, the jig according to the present invention is configured to allow reduction in the number of manually operated processes as described above, and the structure of the jig itself is relatively simple as compared with the structure in PTL 1, so that the jig can be manufactured at low cost.

### BRIEF DESCRIPTION OF DRAWINGS

FIG. 1 is a cross-sectional view showing the state where a spindle is inserted through a roller to which a guide ring is attached, according to the embodiment of the present invention.

FIG. 2 is a cross-sectional view showing the state where the spindle is inserted through the roller to which the guide ring is attached, according to the embodiment of the present invention.

FIG. 3 is a partial cross-sectional front view of a jig for attaching a guide ring to a roller according to the present invention.

FIG. 4 is a cross-sectional view showing a main part of a supporting base and a top plate in the jig for attaching a guide ring to a roller according to the present invention.

FIG. 5 is an enlarged view of a holding protrusion in the jig for attaching a guide ring to a roller according to the present invention.

FIG. 6 is a front view of the top plate as a component of the jig for attaching a guide ring.

FIG. 7 is a top view of the top plate as a component of the jig for attaching a guide ring.

FIG. 8 is a cross-sectional view of the supporting base as a component of the jig for attaching a guide ring.

FIG. 9 is a top view of the supporting base as a component of the jig for attaching a guide ring.

FIG. 10 is a cross-sectional view of a collar as a component of the jig for attaching a guide ring.

FIG. 11 is a cross-sectional view showing the state where the collar is attached to the supporting base, which constitutes the jig for attaching a guide ring.

FIG. 12 is a diagram illustrating the process of attaching a guide ring to a roller.

FIG. 13 is a diagram illustrating the process of attaching a guide ring to a roller.

FIG. 14 is a diagram illustrating the process of attaching a guide ring to a roller.

FIG. 15 is a diagram illustrating the process of attaching a guide ring to a roller.

FIG. 16 is a diagram illustrating the process of attaching a guide ring to a roller.

FIG. 17 is a diagram illustrating the process of attaching a guide ring to a roller.

FIG. 18 is a diagram showing the state where a guide ring is attached to a roller, according to the second embodiment.

FIG. 19 is a diagram showing the state where a guide ring is attached to a roller, according to the third embodiment.

FIG. 20 is a diagram showing a main part of a jig for attaching a guide ring, according to the third embodiment.

FIG. 21 is a diagram showing a prior art example.

FIG. 22 is a diagram showing a prior art example.

FIG. 23 is a diagram showing another prior art example.

FIG. 24 is a diagram showing another prior art example.

FIG. 25 is a diagram showing another prior art example.

FIG. 26 is a diagram showing another prior art example.

FIG. 27 is a diagram showing another prior art example.

### DESCRIPTION OF EMBODIMENTS

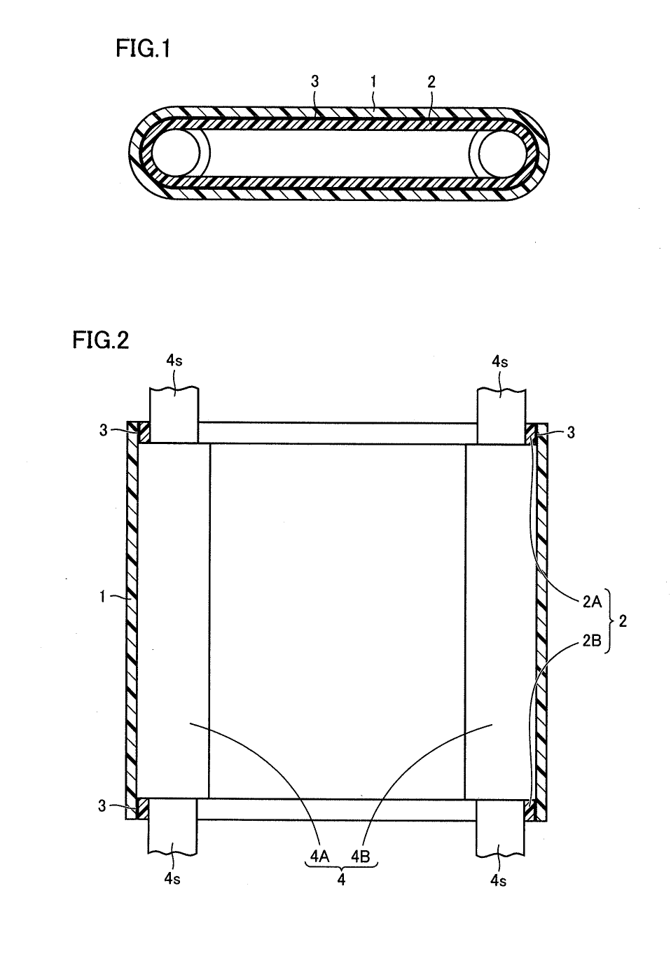

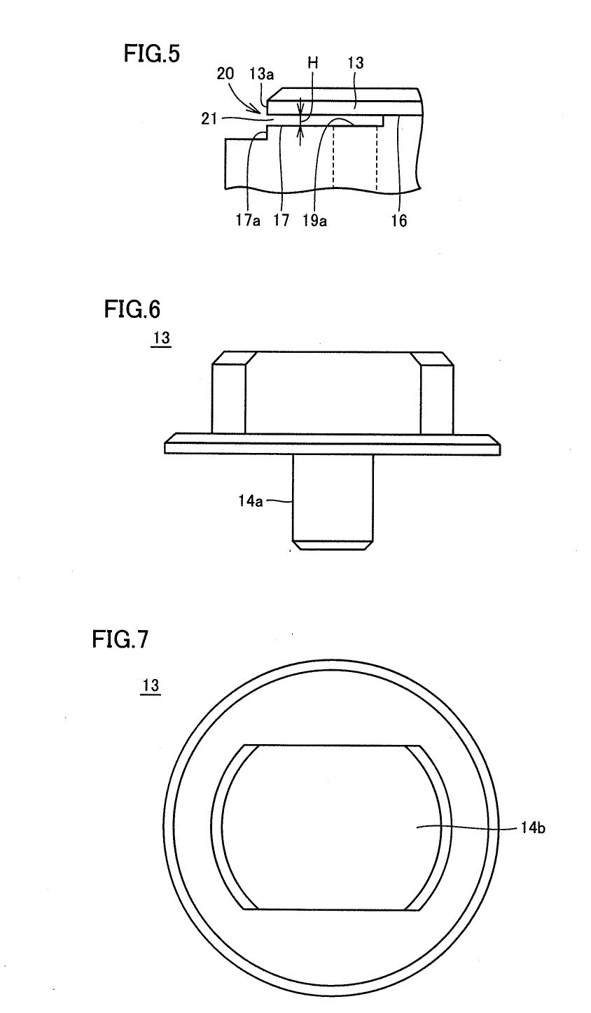

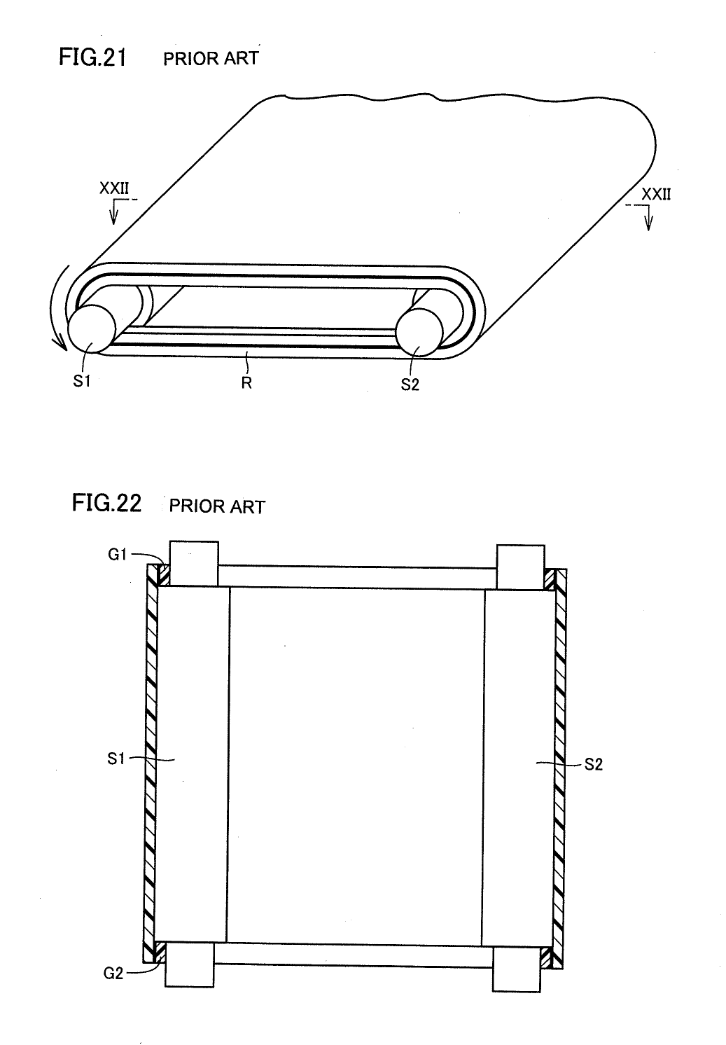

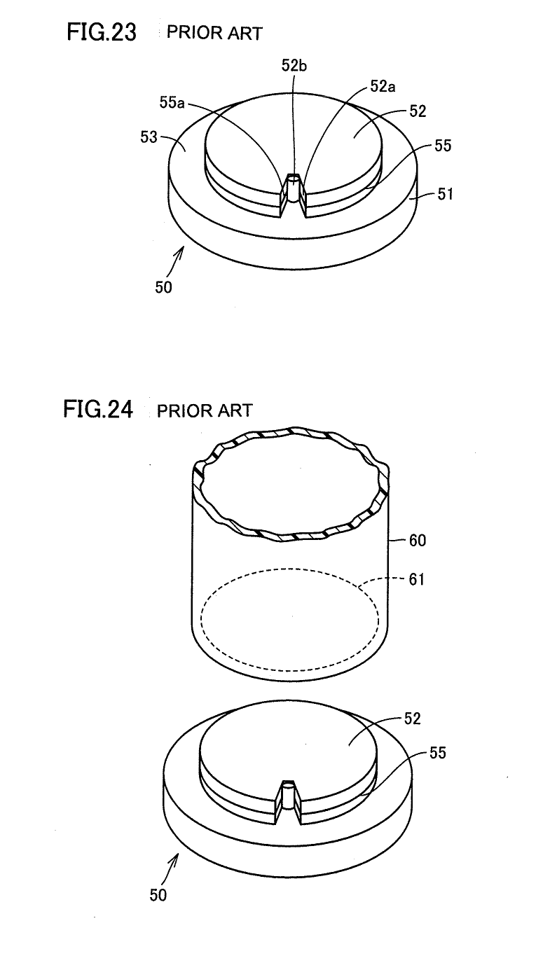

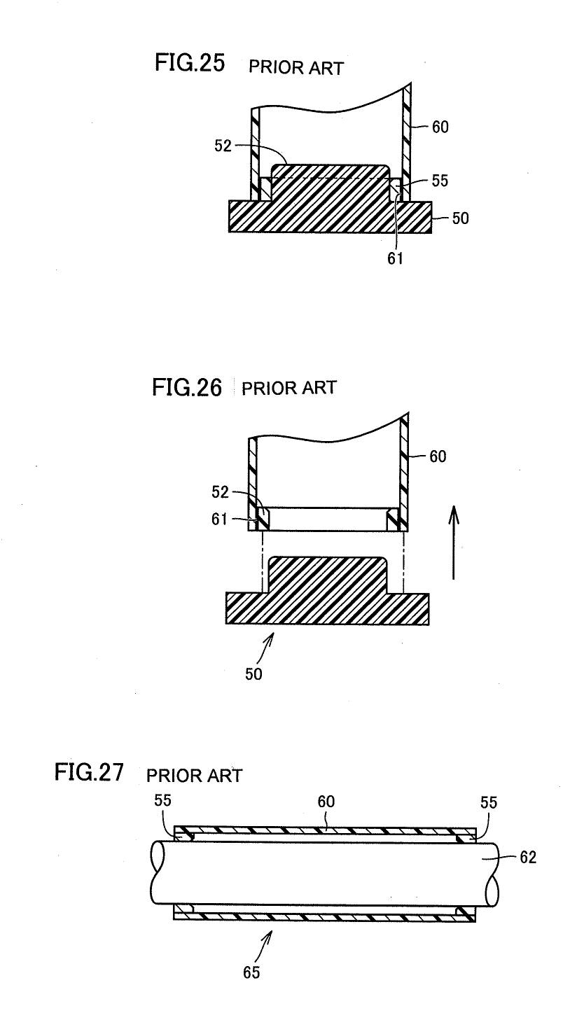

The embodiments of the present invention will be hereinafter described with reference to the drawings. FIGS. 1 to 17 each show a fixing roller that is formed using a jig according to the present invention. The fixing roller has the same shape as that of the fixing roller shown in FIGS. 21 and 22 and is formed of a roller 1 (which will be also referred to as a belt) made of polyimide (PI) and having an elliptical cylindrical body. A guide ring 2 (2A, 2B) formed of a rubber ring made of silicone rubber is adhesively fixed by an adhesive 3 to the inner circumferential surface of roller 1 on both ends in the axis direction. Two spindles 4 (4A, 4B) each formed of a metal round bar are pivotally supported on both ends of roller 1 in the axis direction, and roller 1 is fit onto guide ring 2 without causing displacement in the axis direction in the state where guide ring 2 is interposed between the inner circumferential surface of roller 1 and an outer circumferential surface of a small diameter portion 4s on each of both ends of each spindle 4 in the longitudinal direction. Although the number of spindles is two in the present embodiment, the number of spindles may be two or more.

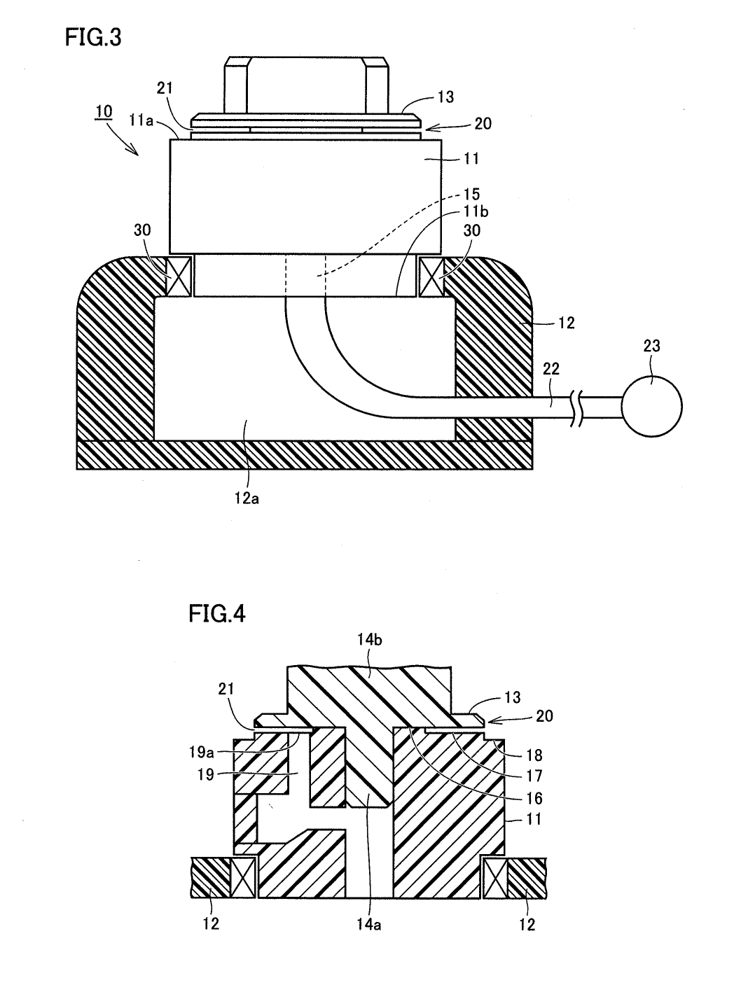

In order to adhesively fix guide ring 2 (2A, 2B) to the inner circumferential surface of roller 1 on both ends in the axis direction, jig 10 shown in each of FIGS. 3 to 11 is used.

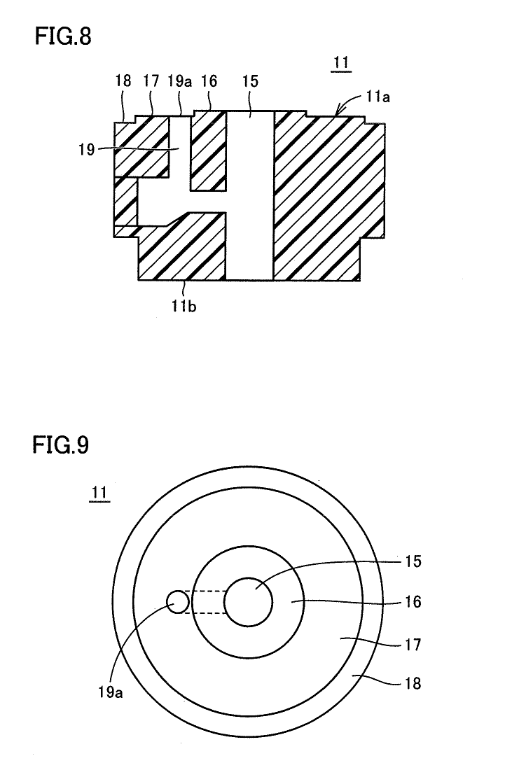

Jig 10 is rotatably disposed through a bearing 30 on a cylindrical base 12 that is slightly larger than a circular seat-shaped supporting base 11. A top plate 13 is fixed by screw fastening on the upper surface of supporting base 11. As shown in FIGS. 6 and 7, a screw rod 14a is provided so as to protrude in the center on the lower surface of top plate 13 while a knob 14b for screw fastening is provided so as to protrude on the upper surface. As shown in FIGS. 8 and 9, supporting base 11 is configured to have a screw hole 15 opened in the center of an upper surface 11a and vertically penetrating through supporting base 11, and screw rod 14a of top plate 13 is inserted from above into this screw hole and fastened, to fix top plate 13 to the upper surface of supporting base 11.

Upper surface 11a of supporting base 11 is provided with an annular high step portion 16 surrounding screw hole 15 and an annular middle step portion 17 on the outer circumference of high step portion 16, in which middle step portion 17 is equal in outer diameter to top plate 13. Middle step portion 17 is provided on its outer circumference with a low step portion 18 formed of upper surface 11a of the supporting base. Low step portion 18 serves as a plane with which guide ring 2 and roller 1 come into contact. Furthermore, an end opening 19a of a decompression hole 19 is opened in middle step portion 17, and this decompression hole 19 is bent within supporting base 11 so as to be in communication with screw hole 15. Screw hole 15 is opened in the center of a lower surface 11b of supporting base 11, and a decompression hose 22 connected to a vacuum source 23 is in communication with a hollow portion 12a of base 12.

Screw rod 14a is screwed into screw hole 15 of supporting base 11 to bring the lower surface in the center of top plate 13 into contact with the upper surface of high step portion 16, in which position the upper plate is fixedly placed. In this state, a holding protrusion 20 is formed to have an outer circumferential surface consisting of an outer circumferential surface 13a of top plate 13 and an outer circumferential surface 17a of middle step portion 17. Holding protrusion 20 includes a gap 21 between the upper surface of middle step portion 17 and the lower surface of top plate 13. This gap 21 is opened toward the outer surface at the intermediate position of the outer circumferential surface of holding protrusion 20. A height H of gap 21 is approximately 1 mm in the present embodiment.

Holding protrusion 20 has an outer diameter R1 smaller than an inner diameter R2 of guide ring 2 (R1<R2), and the difference therebetween (R2−R1) is 0.5 mm to 3 mm. Holding protrusion 20 is configured to have a relatively small outer diameter in this way, to cause a gap to be provided between holding protrusion 20 itself and the inner circumferential surface of guide ring 2, so that guide ring 2 can be overlaid on holding protrusion 20 without being stretched. Also, pressure reduction is performed through decompression hole 19 in the state where guide ring 2 is fit onto holding protrusion 20, to bring the inner circumferential surface of guide ring 2 overlaid on the outer circumferential surface of holding protrusion 20 into close contact with the outer circumferential surface of holding protrusion 20, so as to cause the outer diameter of guide ring 2 to be compressed by 0.5 mm to 3 mm that is a difference of R2−R1 described above. In the present embodiment, guide ring 2 having an outer diameter of 45 mm is compressed to an outer diameter of 44 mm.

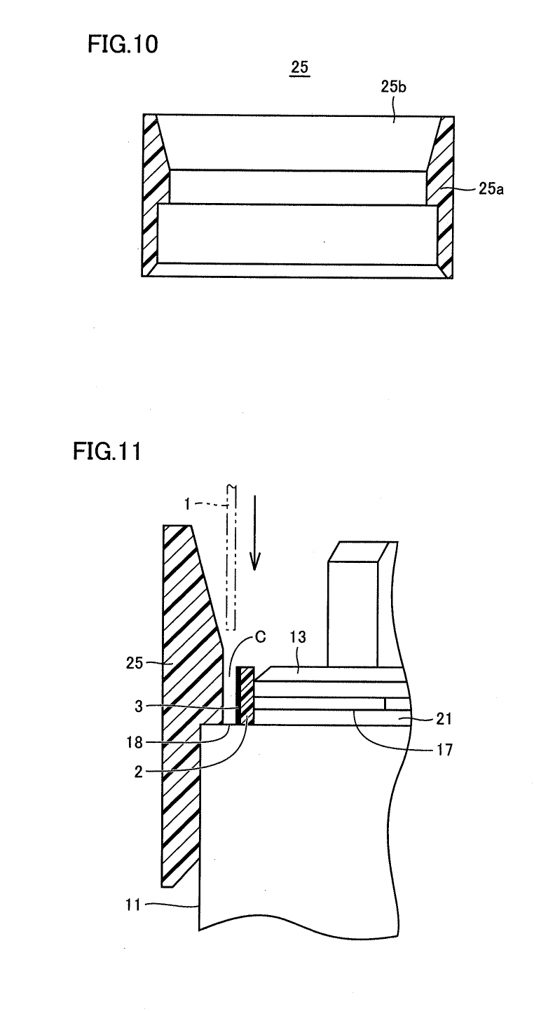

Furthermore, a cylindrical collar 25 shown in FIGS. 10 and 11 is provided. In the state where the guide ring is fit onto holding protrusion 20, collar 25 is engaged with the outer circumference of low step portion 18 of supporting base 11 and attached so as to surround the outer circumferential surface of holding protrusion 20 with a gap provided therebetween. An engagement protrusion 25a is provided in the upper portion of the inner circumferential surface of collar 25 while an outwardly extending tapered portion 25b for facilitating introduction is provided in the upper side portion of engagement protrusion 25a. Engagement protrusion 25a is engaged with the outer peripheral edge of low step portion 18 and attached onto supporting base 11. In this attached state, a gap C between the inner circumferential surface of engagement protrusion 25a and the outer circumferential surface of guide ring 2 compressed by pressure reduction is greater than the thickness of roller 1, so that the tip end portion of roller 1 can be readily inserted into gap C.

Supporting base 11, top plate 13 and collar 25 as components of jig 10 each are formed of polytetrafluoroethylene (PTFE). If PTFE is used as a material, an adhesive accidentally adhering to jig 10 can be easily removed. Then, an explanation will be given with regard to an attachment method for adhesively fixing guide ring 2 to the inner circumferential surface of elliptical roller 1 on both ends in the axis direction by using jig 10 as described above.

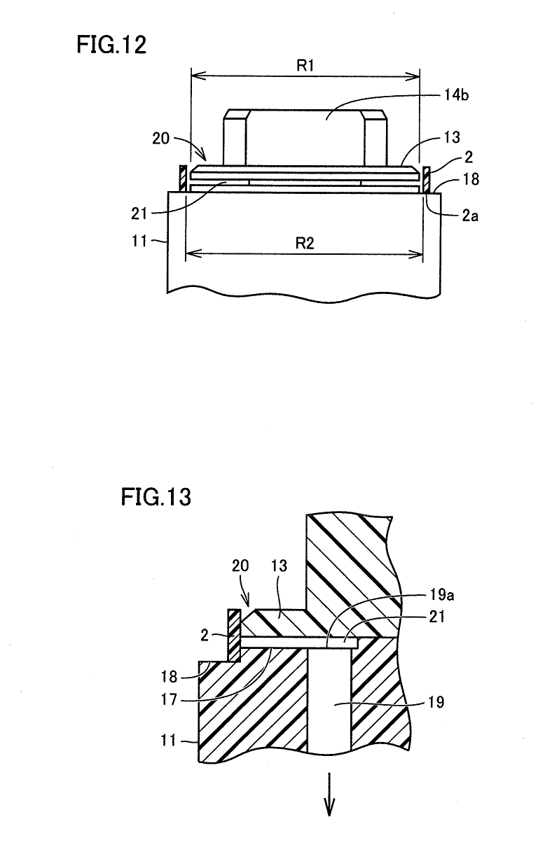

In the first step, as shown in FIG. 12, guide ring 2 is overlaid on the outer circumferential surface of holding protrusion 20 of jig 10 so as to be wound therearound, and an insertion end face 2a of guide ring 2 is brought into contact with low step portion 18 of supporting base 11. At this stopped position, the opening in the outer circumferential surface of gap 21 of holding protrusion 20 is closed by an intermediate portion of the inner circumferential surface of guide ring 2 as seen in the vertical width direction. Since outer diameter R1 of holding protrusion 20 is smaller than inner diameter R2 of guide ring 2, guide ring 2 does not need to be stretched for fitting onto holding protrusion 20. Thus, without changing its original diameter, guide ring 2 can be fit onto the outer circumferential surface of holding protrusion 20, and a gap of about 0.5 mm is provided between the inner circumferential surface of guide ring 2 and the outer circumferential surface of holding protrusion 20.

In the second step, as shown in FIG. 13, a vacuum is introduced into decompression hole 19 of jig 10, and the pressure within gap 21 closed at its outer circumferential surface by guide ring 2 is reduced through end opening 19a of the decompression hole opened to gap 21 of holding protrusion 20, to cause end opening 19a to function as a decompression hole. This causes guide ring 2 to be sucked so as to be brought into close contact with the outer circumferential surface of holding protrusion 20, so that the outer diameter of guide ring 2 is reduced.

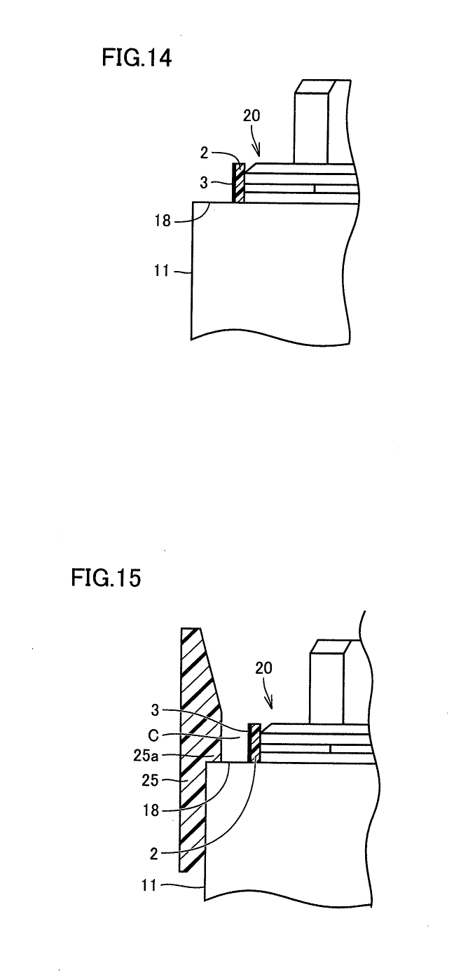

In the third step, as shown in FIG. 14, adhesive 3 is applied with a brush or an application roller to the outer circumferential surface of guide ring 2 that is fit onto the outer circumferential surface of holding protrusion 20 and compressed by pressure reduction. In this case, supporting base 11 is rotated with respect to base 12 through bearing 30, thereby making it easy to apply an adhesive.

In the fourth step, as shows in FIG. 15, in the state where guide ring 2 fit onto holding protrusion 20 is compressed, collar 25 is overlaid from above on supporting base 11 to engage the lower surface of engagement protrusion 25a of collar 25 with the peripheral edge of low step portion 18 of supporting base 11 for attachment. In this state, the inner circumferential surface of engagement protrusion 25a surrounds the outer circumferential surface of guide ring 2 having adhesive 3 applied thereto, with gap C having a prescribed width from this outer circumferential surface.

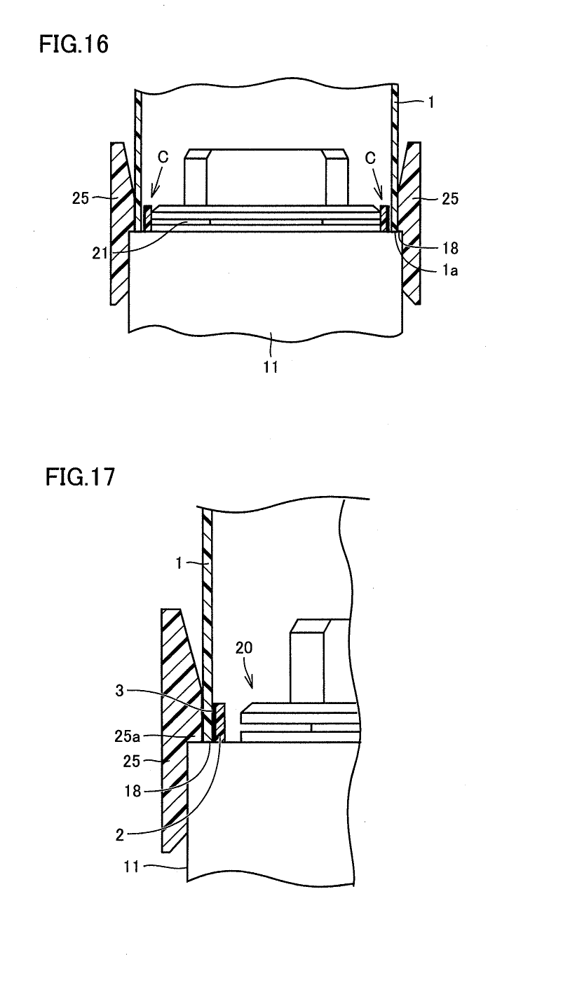

In the fifth step, as shown in FIG. 16, roller 1 formed of a cylindrical sleeve is inserted from above into insertion gap C between guide ring 2 and collar 25 such that an opening 1a on one end in its axis direction faces downward. In this case, since outwardly extending tapered portion 25b for facilitating introduction is provided in the upper side portion on the inner circumferential surface of collar 25, roller 1 can be smoothly inserted into insertion gap C. The end face of roller 1 inserted into gap C is brought into contact with low step portion 18 of supporting base 11, to align this end of roller 1 and the end of guide ring 2 with each other. In the state where roller 1 is inserted into insertion gap C, the inner circumferential surface of roller 1 is not in contact with the outer circumferential surface of guide ring 2 to which adhesive 3 is applied.

In the sixth step, introduction of a vacuum into decompression hole 19 is stopped. In this state, as shown in FIG. 17, guide ring 2 pressed against the outer circumferential surface of holding protrusion 20 is brought back to its original position. Accordingly, the outer diameter of guide ring 2 returns to its original diameter, thereby causing guide ring 2 to be pressed against the inner circumferential surface of roller 1 with adhesive 3 interposed therebetween. Consequently, guide ring 2 is fixedly attached with adhesive 3 to the inner circumferential surface of roller 1 on one end side in the axis direction.

In the seventh step, roller 1 having guide ring 2 adhesively fixed thereto is pulled upward and removed from jig 10. Then, the first to seventh steps are repeated in order to adhesively fix a guide ring 2B to the inner circumferential surface of roller 1 on the other end side. Consequently, as shown in FIGS. 1 and 2, roller 1 is formed such that, on each of both sides in the longitudinal direction of roller 1 having an elliptical cross-sectional shape, guide ring 2 (2A, 2B) is bonded with adhesive 3 to the inner circumferential surface of roller 1 on each of both ends in the axis direction.

By using jig 10 as described above, guide ring 2 can be readily adhesively fixed to the inner circumferential surface of roller 1. Particularly, in the above-described method, the operator manually performs the following operations including: an operation for attaching guide ring 2 to the outer circumferential surface of holding protrusion 20 of jig 10; an operation for applying adhesive 3 to the outer circumferential surface in the state where the attached guide ring 2 is compressed; and a simple operation for inserting roller 1 into insertion gap C between guide ring 2 and collar 25. Since these operations can be performed regardless of whether the operator is skilled or not, variations in accuracy of attaching guide ring 2 do not occur, thereby allowing improvement in quality and in working efficiency.

The present invention is not limited to the above-described embodiments, but may be embodied such that, in the state where guide ring 2 having adhesive 3 adhered thereto is pressed against the inner circumferential surface of roller 1, an elastic pressing tool having a disc shape and made of hard rubber or the like is pressed from the outer surface side of collar 25, to cause the adhesive to be equally spread between roller 1 and the guide ring.

Furthermore, collar 25 of the jig may be eliminated, and after applying adhesive 3 to the outer circumferential surface of guide ring 2, roller 1 may be overlaid on guide ring 2 without attaching collar 25 to supporting base 11. In this case, if an annular recessed portion into which the tip end of roller 1 is fit is provided on the surface of low step portion 18 of supporting base 11, the positional accuracy for inserting roller 1 can be improved.

Furthermore, although jig 10 is configured such that top plate 13 is attachably and detachably screwed onto supporting base 11 to form holding protrusion 20, holding protrusion 20 may be provided by integrally forming supporting base 11 and top plate 13 in advance and a gap may be opened in the outer circumferential surface of holding protrusion 20 at a distance in the circumferential direction.

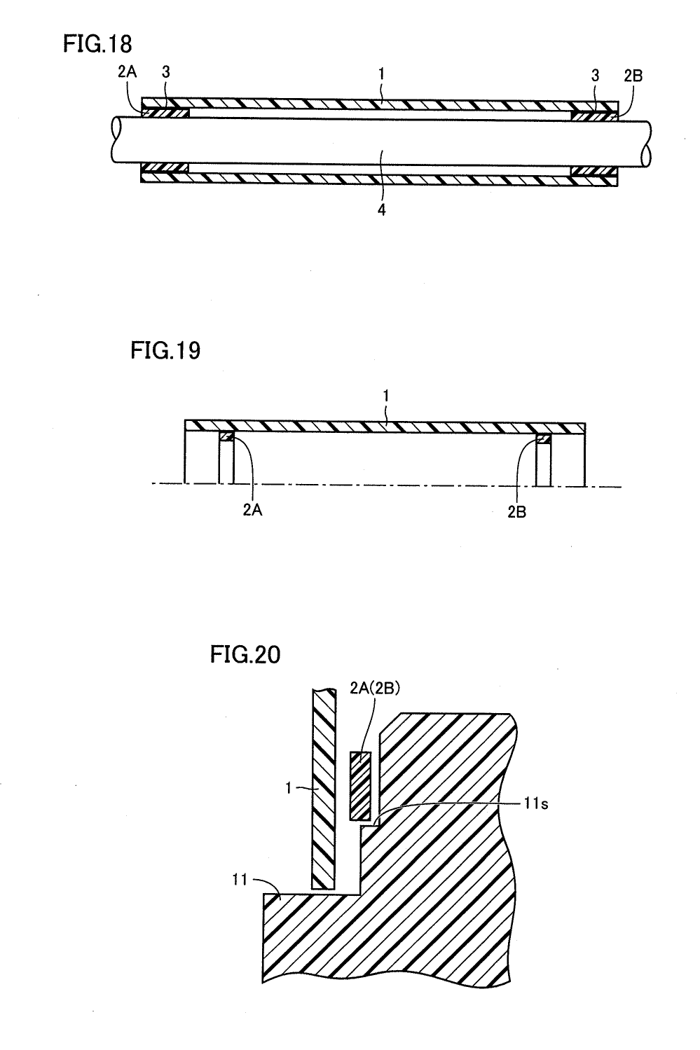

Furthermore, as shown in FIG. 18, jig 10 is suitably used also in the case where roller 1 having a circular cross section is supported by one-axis spindle 4, in which case guide rings 2A and 2B can be readily fixedly attached to both ends of roller 1 in the axis direction by using the above-described jig.

Furthermore, as shown in FIG. 19, in the case where the tip ends of guide rings 2A and 2B are not aligned with the tip end of roller 1 in the axis direction, a step 11s is provided on the outer circumferential surface of supporting base 11 and guide ring 2A (2B) is placed on this step 11s as shown in FIG. 20, which allows guide ring 2 to be fixedly attached to the inner circumferential surface of the roller at a required position.

### REFERENCE SIGNS LIST

1 roller, 2, 2A, 2B guide ring made of a rubber ring, 2a insertion end face, 3 adhesive, 4 spindle, 4s small diameter portion, 10 jig, 11 supporting base, 11a upper surface, 11b lower surface, 11s step, 12 base, 12a hollow portion, 13 top plate, 13a outer circumferential surface, 14a screw rod, 14b knob for a screw, 15 screw hole, 16 high step portion, 17 middle step portion, 18 low step portion, 19 decompression hole, 19a end opening, 20 holding protrusion, 21 gap, 22 decompression hole, 23 vacuum source, 25 collar, 25a engagement protrusion, 25b tapered portion, 30 bearing.

1. A method for adhering a guide ring made of an elastic body to an inner circumferential surface of a cylindrical roller, said method characterized by:
using a jig provided with a holding protrusion from an upper surface of a supporting base;
overlaying said guide ring on an outer circumferential surface of said holding protrusion;
reducing pressure from an inner circumferential side of said guide ring through a decompression hole opened in the outer circumferential surface of said holding protrusion, to bring said guide ring into close contact with the outer circumferential surface of said holding protrusion;
applying an adhesive to an outer circumferential surface of said guide ring;
overlaying said roller on said guide ring from an end opening in an axis direction;
releasing the pressure reduction to restore an outer diameter of said guide ring, to press the adhesive applied to the outer circumferential surface of the guide ring against the inner circumferential surface of said roller; and
removing from said jig said roller having the inner circumferential surface to which said guide ring is adhesively fixed.

2. The method for attaching a guide ring to a roller according to claim 1, wherein
when said guide ring is overlaid on said holding protrusion, an insertion end face of the guide ring is brought into contact with the upper surface of the supporting base of said jig, and an end face of an opening on one end of said roller in the axis direction is also brought into contact with the upper surface of the supporting base of said jig, to adhesively fix one end of said roller in the axis direction and one end of said guide ring in line, and
said guide ring is adhesively fixed also to the inner circumferential surface of said roller on the other end in the axis direction by the same method as said method.

3. The method for attaching a guide ring to a roller according to claim 1, wherein the outer diameter of said guide ring is reduced by 0.5% to 8% in a state where said guide ring is compressed by pressure reduction.

4. The method for attaching a guide ring to a roller according to claim 1, wherein after applying the adhesive to the outer circumferential surface of said guide ring, a collar is disposed with a roller insertion space provided from the outer circumferential surface of said guide ring and said roller is inserted into said roller insertion space, and then, pressure reduction from said guide ring is stopped.

5. A jig used in the method for attaching a guide ring to a roller according to claim 1, wherein
a holding protrusion having an outer diameter smaller than an inner diameter of said guide ring is disposed to protrude from an upper surface of a supporting base, and a decompression hole is opened in an outer circumferential surface of said holding protrusion, said jig comprises
pressure reducing means for reducing pressure through said decompression hole in a state where said guide ring is fit onto said holding protrusion, to bring said guide ring into close contact with the outer circumferential surface of the holding protrusion and allow the guide ring to be compressed.

6. The jig for attaching a guide ring to a roller according to claim 5, wherein
a screw hole is opened in the center on the upper surface of said supporting base in a shape of a circular seat, an annular high step portion surrounding the screw hole is provided, an annular middle step portion is provided in an outer circumference of the high step portion, a decompression hole is opened in the middle step portion, and a low step portion including a surface of said supporting base is provided in an outer circumference of said middle step portion, while a disk-shaped top plate is provided that has a lower surface from which a screw rod protrudes that is to be screwed into the screw hole of said supporting base,
the screw rod of said top plate is screwed into the screw hole of the supporting base, and said top plate is fixedly placed on an upper surface of said high step portion, to provide said holding protrusion having a gap provided between a lower surface of said top plate and an upper surface of said middle step portion, said decompression hole being opened to said gap, and
said guide ring is fit onto the outer circumferential surface of said holding protrusion, and pressure is reduced through said decompression hole from said gap located in an intermediate portion of said holding protrusion, to allow pressure reduction from an inner circumferential side of said guide ring.
